(19) United States
(12) Patent Application Publication
(10) Pub. No.: US 2008/0072435 A1
(43) Pub. Date: Mar. 27, 2008

(54) Baker knife

(75) Inventor: Jaw-Chyi Shieh, Taipei City (TW)

Correspondence Address: JAW-CHYI SHIEN, P.O. BOX 90, Tainan City, 70499, omitted

(73) Assignee: HAUSCO ENTERPRISES CO., LTD.

(21) Appl. No.: 11/527,511

(22) Filed: Sep. 27, 2006

(51) Int. Cl. B26B 3/00

(52) U.S. Cl. 30/142; 15/245

(57) ABSTRACT

A baker knife includes two blades of different Shore hardness to be used by a baker, usable for various processes in making bread and cake. The baker knife is made of silicon.

### BACKGROUND OF THE INVENTION

1. Field of the Invention

This invention relates to a baker knife, particularly to one having two side edges of different hardness, convenient for a baker to use in several processes in making bread and cakes, such as to scoop butter, fillings, or cutting or carving or designing.

2. Description of the Prior Art

In making bread, cakes or the like, necessary ingredients are put in a container, mixed and stirred to become dough, then placed in a mold to form in a shape. Then the formed dough is placed and baked in an oven. In the making processes, various tools are used, and to treat rather soft ingredients such as butter, fillings, etc, tools made of soft material are preferable, like a rubber knife. Then if treating a half hard food such as cake, tools made of hard material is better.

### SUMMARY OF THE INVENTION

This invention has been devised to offer a bakery knife, which can be used for various processes in making bread or cake for a baker.

The feature of the bakery knife in the invention is two kinds of blades are provided in the bakery knife, made of different hardness, one having a Shore hardness 60-70 and the other a Shore hardness 30-35, so the two blades can be used for various processes in making bread and cakes with convenience.

### BRIEF DESCRIPTION OF DRAWINGS

This invention will be better understood by referring to the accompanying drawings, wherein:

FIG. 1 is a perspective view of a baker knife in the present invention; and,

FIG. 2 is a cross-sectional view of the baker knife in the present invention.

### DETAILED DESCRIPTION OF THE PREFERRED EMBODIMENT

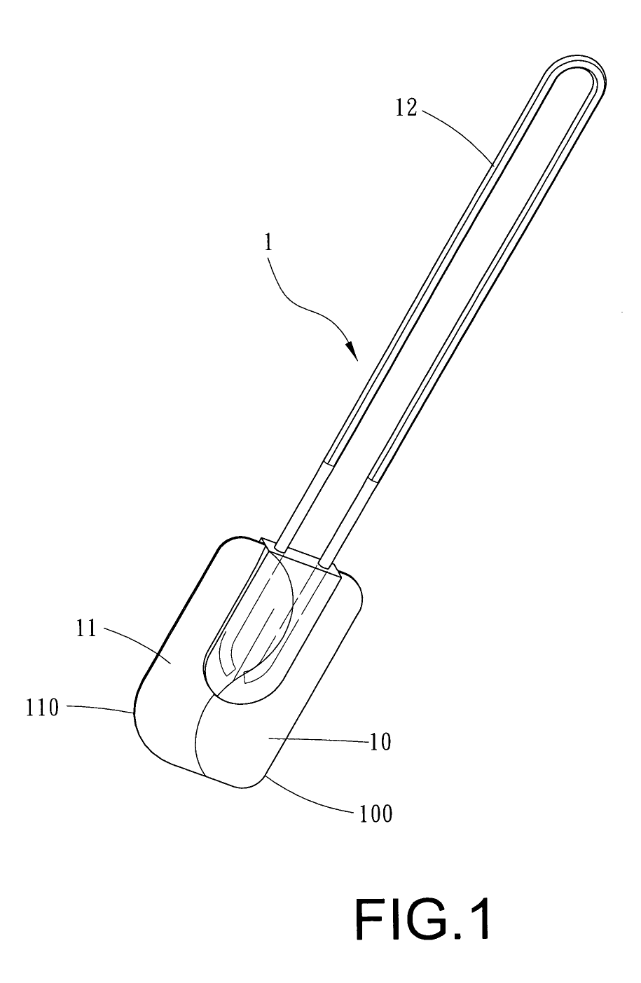

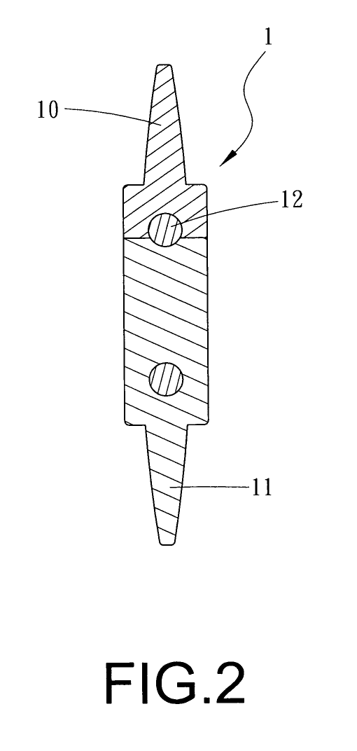

A preferred embodiment of a baker knife in the present invention, as shown in FIGS. 1 and 2, includes a knife body provided with two blades 10 and 11 made of silicon by injecting molding process, and a grip 12.

The first blade 10 is positioned at one side of the knife body, having a Shore hardness 60-70, and a small blade edge 100 at a front end, and the second blade 11 positioned at the other side, having a Shore hardness 30-35 and a large blade edge 110 at a front end.

The grip 12 is shaped elongate and as U, made of a slender wire or plastic or the like, combined with the knife body with its lower end.

In using, the first blade 10 of high hardness is used for cutting bread or cake, and the second blade 11 of low hardness is used for scooping or moving butter, filling, etc. The small blade edge 100 and the large blade edge 110 of the first and the second blade 10 are respectively used for shaving clean dough attached on the bottom of a container or the like.

In addition, as the baker knife is made of silicon, its harness is not so high, aside from used for making bread and cake, possible to be also used for stirring, overturning, shifting food fried on a frying pan, without hurting the frying pan.

While the preferred embodiment of the invention has been described above, it will be recognized and understood that various modifications may be made therein and the appended claims are intended to cover all such modifications that may fall within the spirit and scope of the invention.

What is claimed is:

1. A baker knife comprising two side blades made of silicon, said two blades having different Shore hardness, a first one of said two blades having a Shore hardness 60-70 and a small blade edge at its front end, a second one of said two blades having a Shore hardness 30-35 and a large blade edge at its front end, and an elongate grip having its lower end combined tightly with an upper portion of said baker knife.
